(19) United States
(12) Patent Application Publication
(10) Pub. No.: US 2004/0119698 A1
(43) Pub. Date: Jun. 24, 2004

(54) Method for eliminating a welding line of an upper case of a keyboard and an upper case of a keyboard

(76) Inventors: Shih-Hung Chao, Banciao City (TW); Yu-Hong Liu, Suzhou City (CN)

Correspondence Address: SNELL & WILMER, ONE ARIZONA CENTER, 400 EAST VAN BUREN, PHOENIX, AZ, 850040001

(21) Appl. No.: 10/725,637

(22) Filed: Dec. 2, 2003

(30) Foreign Application Priority Data
Dec. 20, 2002 (TW) 091136924

(51) Int. Cl. G09G 5/00

(52) U.S. Cl. 345/168; 29/525.11

(57) ABSTRACT

A method for eliminating welding line of an upper case of a keyboard and an upper case of a keyboard are provided. The upper case of a keyboard includes an opening. The opening defines a rim. In accordance with the method, a mold is filled with plastic substance using the opening as the melt entrance. Then the mold is released to get the semi-finished upper case. Finally a movable housing is affixed on the rim of the opening to finish the upper case.

### CROSS-REFERENCE TO RELATED APPLICATION

This application claims priority of Taiwan Patent Application Serial No. 091136924 filed on Dec. 20, 2002.

### FIELD OF THE INVENTION

The invention relates to a method for forming an upper case of a keyboard and to an upper case of a keyboard.

### BACKGROUND OF THE INVENTION

Referring to FIG. 1, the final product of an upper case of a keyboard includes many immovable housings. Each housing is provided for inserting one key cap. Therefore, the melt plastic is filled through the gap between the immovable housings rather than through the immovable housing upon the manufacturing of the upper case with conventional method. Thus, the entrance 101 with a diameter less than 1 mm is adapted.

Because the diameter of the entrance 101 is less than 1 mm, more entrances for filling are needed for complete shaping. However, a need of longer runners for the melt plastic and the appearance of welding line will be the problem in multiple-entrance case.

### SUMMARY OF THE INVENTION

The present invention provides a method for forming an upper case of a keyboard and an upper case of a keyboard. Thereby, the welding line can be eliminated.

Referring to FIG. 2, the invention utilizes single entrance 201, thereby eliminating the welding line created by the meeting of the melt plastic. Due to the single entrance, an entrance 201 with a larger diameter is needed. Therefore, an opening 205 is provided for filling the melt plastic. After mold being released, a movable housing is added to form the complete upper case of the keyboard.

The upper case of the invention includes an opening. The method for forming the upper case of the keyboard is described as follows. First the melt plastic pours into the mold using the opening as an entrance to form a semi-finished product of the upper case. Then the mold is released, and the semi-finished product of the upper case is taken out. Scrap is cut out and gate is removed. Finally, a movable housing is affixed on the rim of the opening. Thereby, a final product of the upper case of the keyboard is obtained.

The product of the upper case of the keyboard includes a panel and a movable housing. The panel has an integrally formed immovable housing and an opening. Being formed non-integrally with the panel, the movable housing is affixed on the rim of the opening.

In the present invention, the diameter of the rim is not less than 1 mm. The movable housing is affixed on the rim of the opening by screw, lodging in, thermal fusion, or other method resulting in the same effect.

### BRIEF DESCRIPTION OF THE DRAWINGS

FIG. 1 is a schematic view of an embodiment according to the prior art;

FIG. 2 is a schematic view of an embodiment of the present invention;

FIG. 3 is a flow chart of an embodiment of the method according to the present invention;

FIG. 4 is a schematic view illustrating the step 304 in FIG. 3;

FIG. 5 is a schematic view illustrating the step 308 in FIG. 3;

FIG. 6 is a schematic view illustrating the step 310 in FIG. 3, and

FIG. 7 is a schematic view of an embodiment of the upper case of the keyboard according to the present invention.

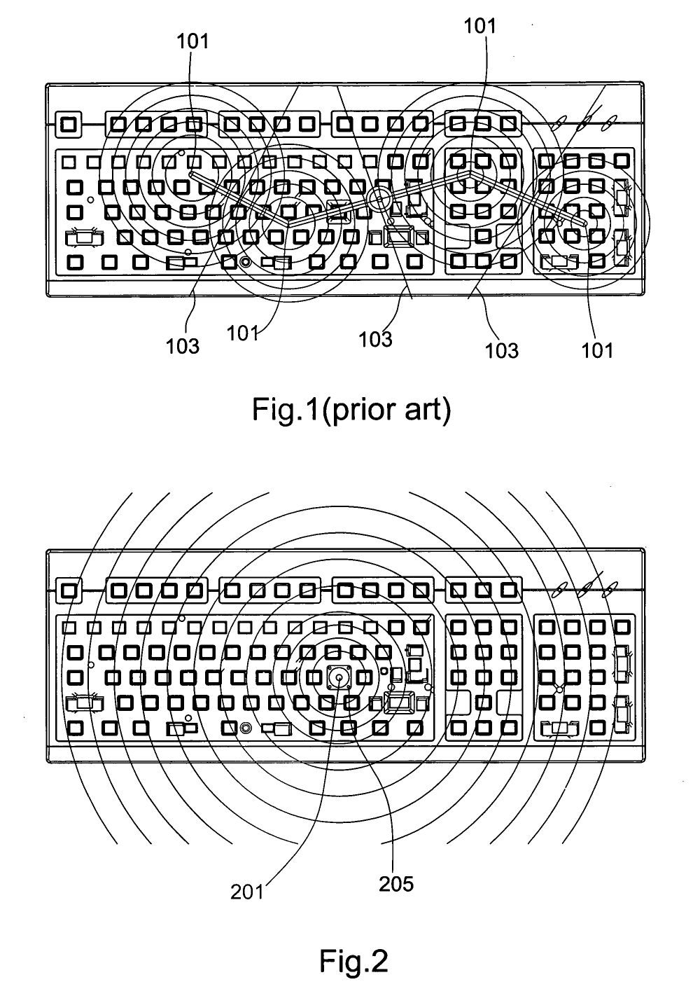

### DETAILED DESCRIPTION

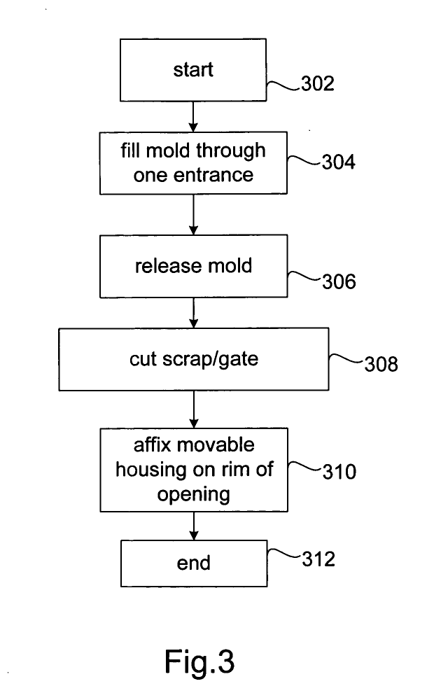

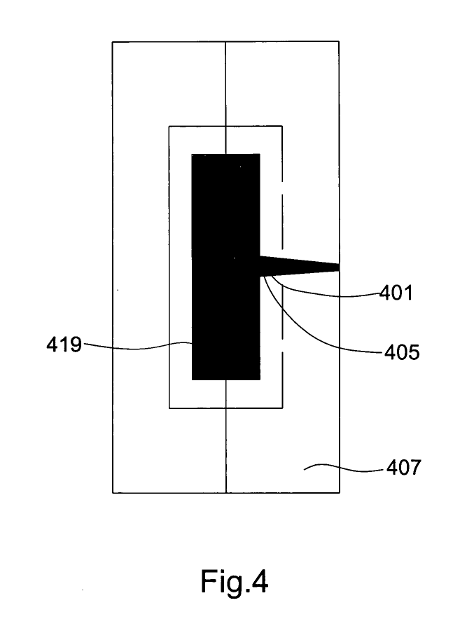

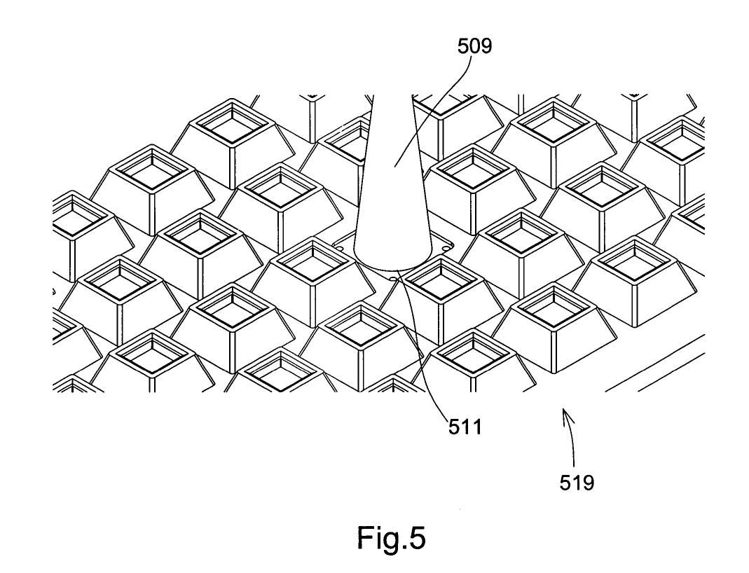

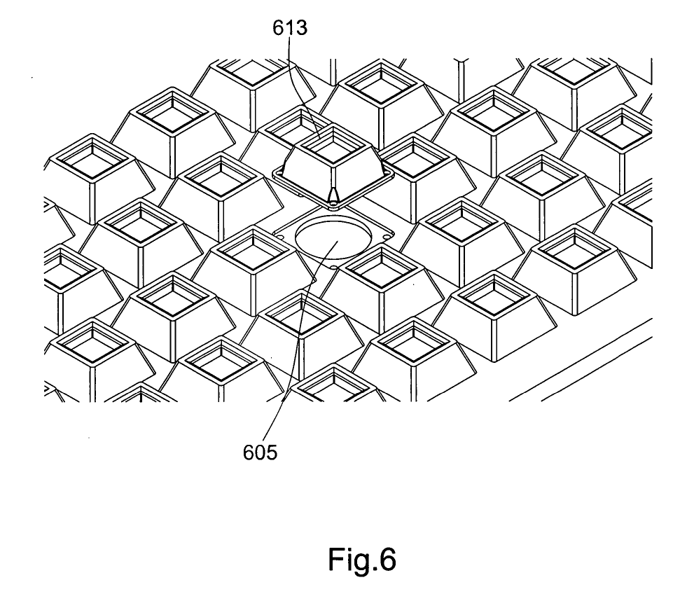

FIG. 3 is a flow chart of the embodiment of the method according to the present invention. The upper case of the keyboard in this embodiment includes an opening. Referring to FIGS. 3 and 4, the rim of the opening 405 is used as an entrance (entrance 401). The melt plastic is filled into the mold 407 to form the semi-finished upper case 419 (step 304). Then the mold 407 is released to retrieve the semi-finished upper case 419 (step 306). Referring to FIGS. 3 and 5, the scrap 509 of the semi-finished upper case 519 is cut off and the gate 511 is removed (step 308). Referring to FIGS. 3, 6 and 7, the movable housing 613 is affixed on the rim of the opening 605 (step 310) to obtain the final product 721 of the upper case.

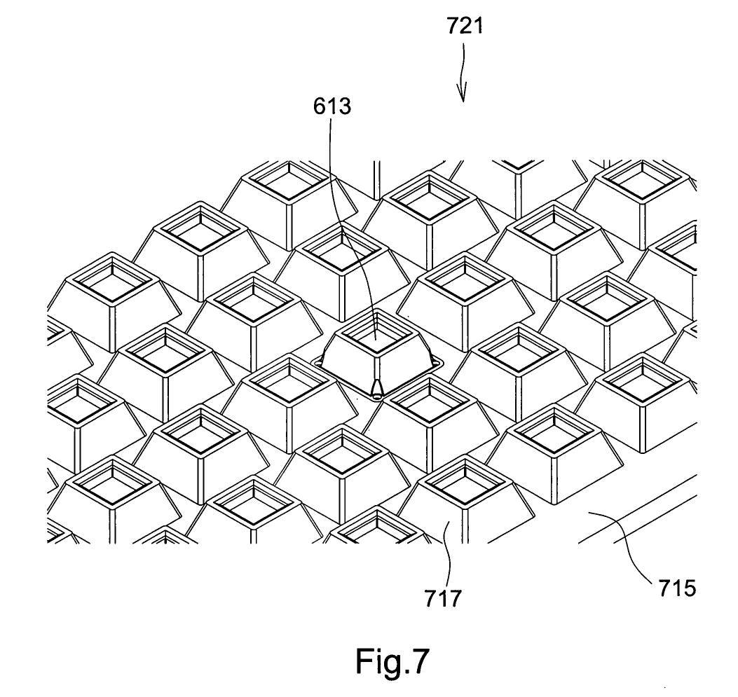

FIG. 7 is a schematic view of the embodiment of the upper case of the keyboard according to the present invention. The product of the upper case 721 includes a panel 715 and a movable housing 613. The panel 715 has a plurality of integrally formed immovable housings 717 and an opening (not shown). Being formed non-integrally with the panel 715, the movable housing 613 is affixed on the rim of the opening.

In the embodiment of the invention, the diameter of the rim of the opening 405 is not less than 1 mm. The movable housing 613 is affixed on the rim of opening 605 by various methods, for example, the movable housing 613 being secured on the rim of the opening 605 by one or more screws, the movable housing 613 being lodged in the opening 605, the movable housing 613 being fused and affixed on the rim of the opening 605, or other methods that result in the same effect.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A method of forming an upper case of a keyboard, said upper case of a keyboard including an opening, said opening defining a rim, said method comprising:
(a) filling a mold with plastic substance using said opening as an entrance to form a semi-finished upper case;
(b) releasing said mold to retrieve said semi-finished upper case; and
(c) affixing a movable housing on said rim of said opening.

2. The method of claim 1, further comprising cutting a scrap between said step (b) and said step (c).

3. The method of claim 2, wherein a diameter of said opening is not less than 1 mm.

4. The method of claim 2, wherein in said step (c), said movable housing is affixed on said rim of said opening by one or more screws.

5. The method of claim 2, wherein in said step (c), said movable housing is lodged in said rim of said opening.

6. The method of claim 2, wherein in said step (c), said movable housing is fused and affixed on said rim of said opening.

7. The method of claim 1, further comprising cutting a gate between said step (b) and said step (c).

8. An upper case of a keyboard, comprising:
a panel including an opening and an integrally formed immovable housing, said opening defining a rim; and
a movable housing affixed on said rim of said opening, wherein said movable housing is formed non-integrally with said panel.

9. The upper case of a keyboard of claim 8, wherein said movable housing is affixed on said rim of said opening by one or more screws.

10. The upper case of a keyboard of claim 8, wherein said movable housing is lodged in said rim of said opening.

11. The upper case of a keyboard of claim 8, wherein said movable housing is fused and affixed on said rim of said opening.
